(19) United States
(12) Patent Application Publication
(10) Pub. No.: US 2020/0304615 A1
(43) Pub. Date: Sep. 24, 2020

(54) Extension Lens Module

(71) Applicants: Sintai Optical (Shenzhen) Co., Ltd., ShenZhen City (CN); Asia Optical Co., Inc., Taichung (TW)

(72) Inventor: Jing-Long Liu, ShenZhen City (CN)

(21) Appl. No.: 16/792,392

(22) Filed: Feb. 17, 2020

(30) Foreign Application Priority Data
Mar. 18, 2019 (CN) 201910202308.7

(51) Int. Cl. H04M 1/02; H04N 5/225; G02B 15/04; G02B 15/10; G02B 7/16; G02B 13/00

(52) U.S. Cl. CPC H04M 1/0264; H04N 5/2257; G02B 13/001; G02B 15/10; G02B 7/16; G02B 15/04

(57) ABSTRACT

An extension lens module for an electronic device having a lens includes a seat body and a switching device. The seat body is configured to be detachably disposed on the electronic device and includes a positioning pillar. The switching device includes a rotating disc and a plurality of extension lenses, wherein the rotating disc is rotatable with respect to the seat body in an extending direction which is perpendicular to the seat body, and the extension lenses are disposed on the rotating disc at intervals.

### BACKGROUND OF THE INVENTION

### Field of the Invention

The invention relates to an extension lens module, and more particularly to an extension lens module applied to an electronic device.

### Description of the Related Art

Generally, a lens of an electronic device (e.g. smart phone and tablet) has limited camera function because of specification of hardware. Therefore, an electronic device may be used along with an extension lens to obtain extra camera functions (e.g. macro, telephoto or wide-angle camera function).

However, the manufacturers need to produce different protective cases to match different types of electronic devices so that the manufacturing cost is increased. Furthermore, since the protective case would affect the appearance of the electronic device, some consumers are not willing to use an electronic device with a protective case attached thereto. Also, although various protective cases are commercially available, there is no guarantee that they can satisfy each of the consumers.

The extension lens can be mounted on the electronic device by the clamping member. During the assembly, a little adjustment is required so that the extension lens can be directed at the lens of the electronic device. the clamping member might shield part of display of the electronic device. Also, the user has to remove the extension lens from the electronic device in order to use another extension lens having different camera function. Furthermore, if the electronic device has a protective case mounted thereon, the accuracy of positioning the extension lens (mounted on the electronic device through the clamping member) with respect to the electronic device cannot be controlled well. In brief, the commercially available extension lenses have some limitations in use.

### BRIEF SUMMARY OF THE INVENTION

The invention provides an extension lens module including a seat body and a switching device. No matter if the electronic device has a protective case mounted thereon, the switching device can be disposed on the electronic device through the seat body, with the extension lens of the switching device directed at the lens of the electronic device.

The extension lens module for an electronic device having a lens in accordance with an embodiment of the invention includes a seat body and a switching device. The seat body is configured to be detachably disposed on the electronic device and includes a positioning pillar. The switching device includes a rotating disc and a plurality of extension lenses, wherein the rotating disc is rotatable with respect to the seat body in an extending direction which is perpendicular to the seat body, and the extension lenses are disposed on the rotating disc at intervals.

In another embodiment, the rotating disc includes a hole, the positioning pillar is penetrated through the hole, so that the rotating disc is movable with respect to the seat body in the extending direction.

In yet another embodiment, the rotating disc includes a plurality of positioning rings, and positions in which the extension lenses are disposed on the rotating disc correspond to positions of the positioning rings on the rotating disc. When one of the positioning rings is directed at the lens of the electronic device and is in contact with the electronic device, the extension lens corresponding to the positioning ring is aligned with the lens of the electronic device.

In another embodiment, a first supporting arm is extended from a first end of the seat body along a first axis, a second supporting arm is extended from a second end of the seat body that is opposite to the first end along the first axis, and one of the first supporting arm and the second supporting arm is provided with an elastic element so that the electronic device is held between the first supporting arm and the second supporting arm.

In yet another embodiment, the other one of the first supporting arm and the second supporting arm is provided with a first adjusting knob configured to move the switching device along the first axis.

In another embodiment, a third supporting arm is extended from a third end of the seat body along a second axis, the second axis is perpendicular to the first axis, and the third supporting arm is provided with a second adjusting knob configured to move the switching device along the second axis.

In yet another embodiment, the rotating disc further includes a hole, an elastic element is disposed between the positioning pillar of the seat body and an inner surface of the hole of the rotating disc, the seat body further includes at least one opening hole, the opening hole is configured to allow an optical axis of one of the extension lenses to pass through, a height of the opening hole is smaller than a height of each of the positioning rings, the opening hole is configured to accommodate one of the positioning rings, and a diameter of the opening hole equals an outer diameter of each of the positioning rings so that each of the positioning rings can be tightly fitted in the opening hole, each of the positioning rings has a height, and the height equals a rear focal length of the extension lens corresponding to the positioning ring.

In another embodiment, each of the positioning rings has a height, and the height equals a rear focal length of the extension lens corresponding to the positioning ring.

In yet another embodiment, the seat body further includes at least one opening hole, a height of the opening hole is smaller than a height of each of the positioning rings, the opening hole is configured to accommodate one of the positioning rings, and a diameter of the opening hole equals an outer diameter of each of the positioning rings so that each of the positioning rings can be tightly fitted in the opening hole.

In another embodiment, the rotating disc further includes a hole, an elastic element is disposed between the positioning pillar of the seat body and an inner surface of the hole of the rotating disc, the opening hole is configured to allow an optical axis of one of the extension lenses to pass through.

In yet another embodiment, the seat body further includes at least one opening hole, a height of the opening hole is smaller than a height of each of the positioning rings, the opening hole is configured to accommodate one of the positioning rings, and a diameter of the opening hole equals an outer diameter of each of the positioning rings so that each of the positioning rings can be tightly fitted in the opening hole.

In another embodiment, a first supporting arm is extended from a first end of the seat body along a first axis, a second supporting arm is extended from a second end of the seat body that is opposite to the first end along the first axis, and one of the first supporting arm and the second supporting arm is provided with an elastic element so that the electronic device is held between the first supporting arm and the second supporting arm.

In yet another embodiment, the other one of the first supporting arm and the second supporting arm is provided with a first adjusting knob configured to move the switching device along the first axis.

In another embodiment, a third supporting arm is extended from a third end of the seat body along a second axis, the second axis is perpendicular to the first axis, and the third supporting arm is provided with a second adjusting knob configured to move the switching device along the second axis.

In yet another embodiment, the rotating disc includes a plurality of positioning rings, each of the positioning rings has a height, and the height equals a rear focal length of the extension lens corresponding to the positioning ring.

In another embodiment, the rotating disc includes a plurality of positioning rings, the seat body further includes at least one opening hole, a height of the opening hole is smaller than a height of each of the positioning rings, the opening hole is configured to accommodate one of the positioning rings, and a diameter of the opening hole equals an outer diameter of each of the positioning rings so that each of the positioning rings can be tightly fitted in the opening hole.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view showing that an extension lens module in accordance with a first embodiment of the invention is applied to an electronic device;

FIG. 2 is a schematic view of the extension lens module of FIG. 1;

FIG. 3 is another schematic view of the extension lens module of FIG. 1;

FIG. 4 is an exploded view of the extension lens module of FIG. 2, where a third supporting arm and related structure thereof are omitted;

FIG. 5 is a sectional view of the extension lens module of FIG. 1 along line A-A;

FIG. 6 is a sectional view of the extension lens module of FIG. 1 along line B-B;

FIG. 7 is a schematic view of an extension lens module in accordance with a second embodiment of the invention.

### DETAILED DESCRIPTION OF THE INVENTION

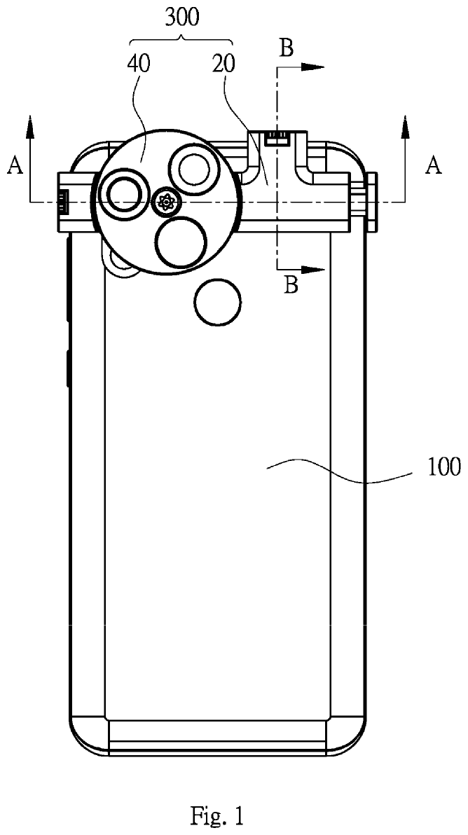

Referring to FIG. 1, an extension lens module 300 in accordance with a first embodiment of the invention includes a supporting frame 20 and a switching device 40, wherein the switching device 40 is disposed on an electronic device 100 through the supporting frame 20 for providing multiple camera functions (e.g. macro, telephoto or wide-angle camera function) for the electronic device 100.

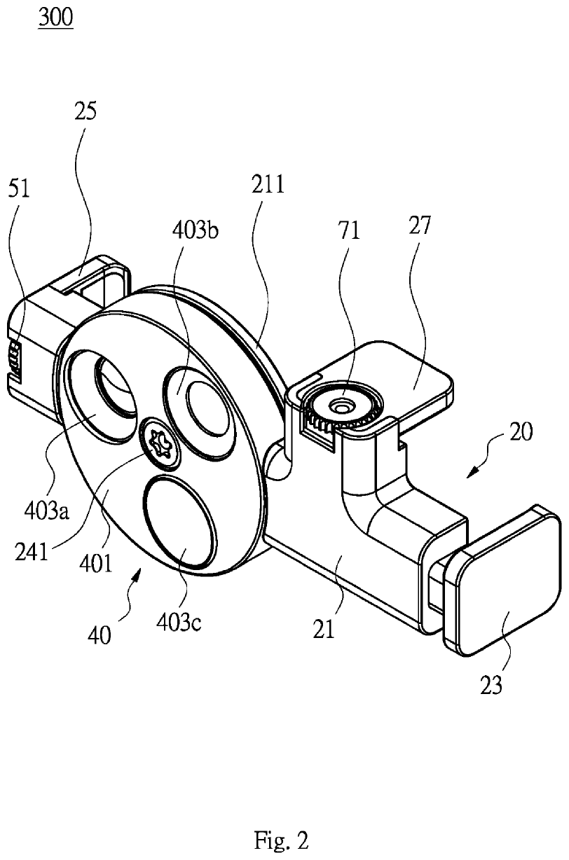

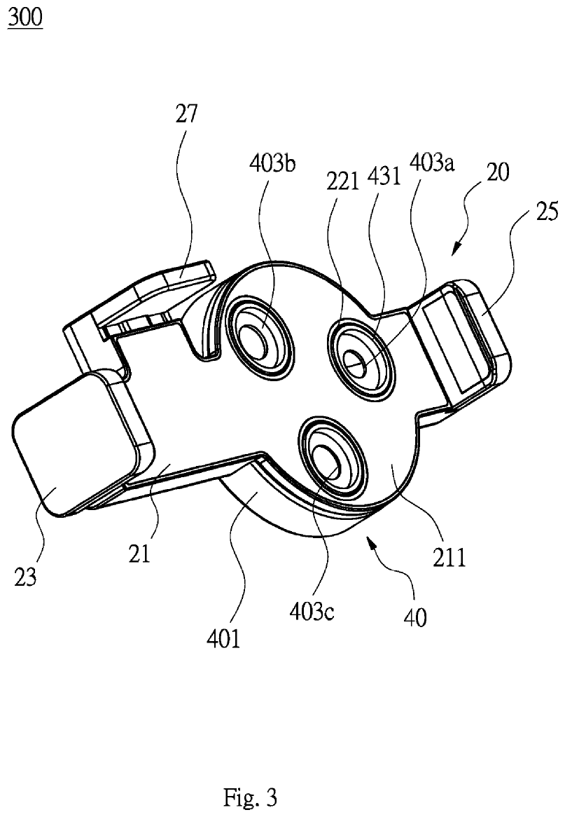

Referring to FIGS. 2 and 3, the supporting frame 20 includes a seat body 21, a first supporting arm 23, a second supporting arm 25 and a third supporting arm 27. The seat body 21 is configured to be detachably disposed on the electronic device 100, and the first supporting arm 23, the second supporting arm 25 and the third supporting arm 27 are movably disposed on the seat body 21. The switching device 40 is rotably disposed on the seat body 21 and includes a rotating disc 401 and a plurality of extension lenses 403a-403c having different camera function, and the extension lenses 403a-403c are disposed on the rotating disc 401 at intervals. As shown in FIG. 3, the rotating disc 401 further includes a plurality of positioning rings 431, and the positioning rings 431 are extended from the extension lenses 403a-403c towards a side of the electronic device 100. That is to say, the positions in which the extension lenses 403a-403c are disposed on the rotating disc 401 respectively correspond to those of the positioning rings 431 on the rotating disc 401. In the first embodiment, the positioning rings 431 and the extension lenses 403a-403c are integrally formed as a continuous-unity piece. However, it is understood that the positioning rings 431 and the extension lenses 403a-403c can be formed as two groups of separated pieces that could be assembled. It is also understood that the positioning rings 431 can be extended from the rotating disc 401 towards the side of the electronic device 100.

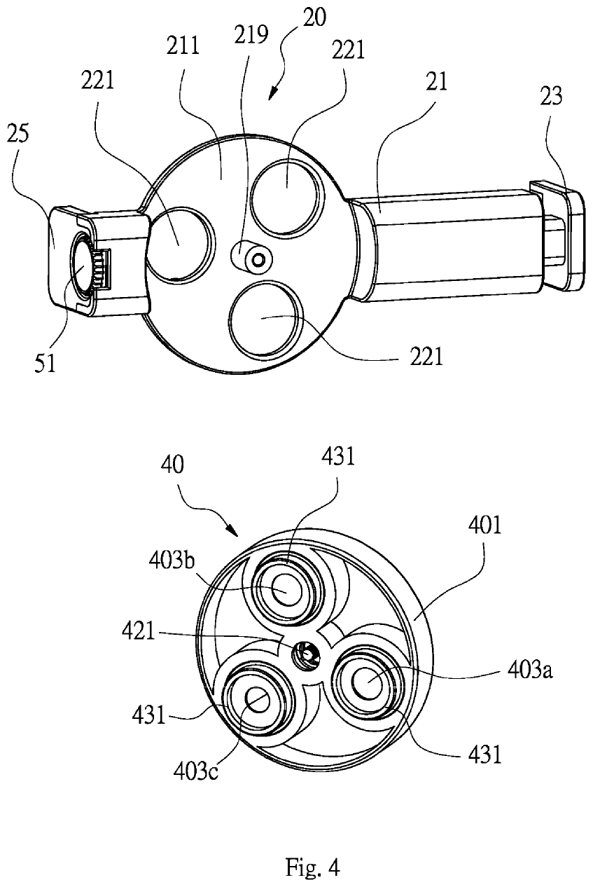

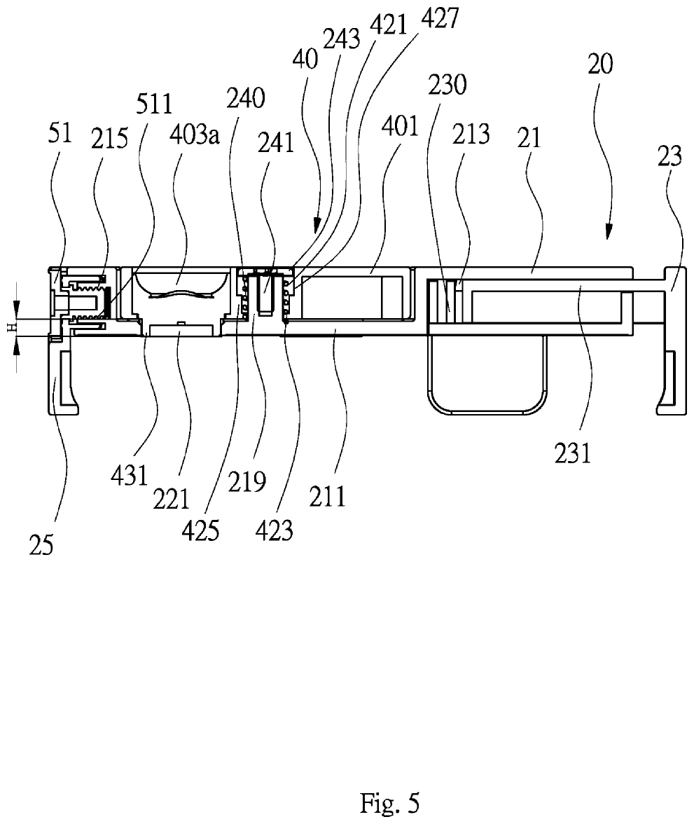

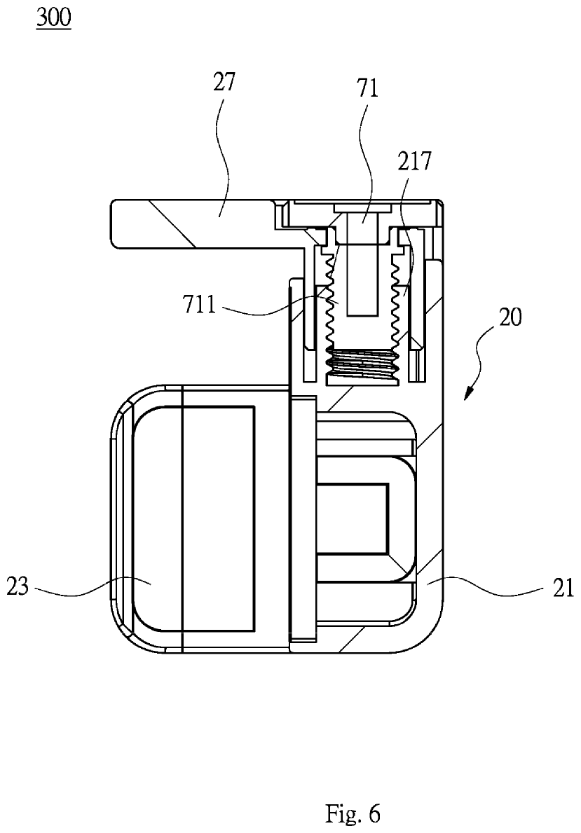

Referring to FIGS. 4-6, FIG. 4 is an exploded view of the extension lens module of FIG. 2, wherein a third supporting arm and related structure thereof are omitted, and FIGS. 5-6 respectively depict the sectional view of the extension lens module 300 of FIG. 1 along the line A-A and the line B-B. The seat body 21 includes a lens positioning portion 211, a guiding groove 213 (as shown in FIG. 5), a first thread hole 215 (as shown in FIG. 5) and a second thread hole 217 (as shown in FIG. 6). The guiding groove 213 and the first thread hole 215 define a first axis (not shown), and the second thread hole 217 defines a second axis (not shown). The first axis is parallel to a horizontal direction, and the second axis is parallel to a vertical direction. In other words, the first axis is perpendicular to the second axis.

As shown in FIG. 4, the lens positioning portion 211 includes a positioning pillar 219 and a plurality of opening holes 211. The opening holes 211 are arranged along a circumferential direction of the positioning pillar 209, are disposed on the positioning pillar 209 at intervals, correspond to the positioning rings 431 on the switching device 40 and are configured to accommodate the positioning rings 431 so as to allow optical axes of the extension lenses 403a-403c to pass through. In the first embodiment, the positioning pillar 219 and the seat body 21 are integrally formed as a continuous-unity piece. However, it is understood that the positioning pillar 219 and the seat body 21 can be two separated pieces to be assembled. The rotating disc 401 further includes a hole 421 through which the positioning pillar 219 is penetrated, so that the rotating disc 401 surrounds the positioning pillar 219. Therefore, the rotating disc 401 can be moved in an extending direction (that is, a direction perpendicular to the electronic device 10) of the positioning pillar 219 and can be rotated with respect to the lens positioning portion 211, so as to switch between the extension lenses 403a-403c having different camera function. The clamping member might shield part of display of the electronic device. As shown in FIG. 5, a first flange 423 and a second flange 425 are formed on an inner surface 427 of the hole 421, wherein an inner diameter of the first flange 423 is smaller than an inner diameter of the second flange 425. An elastic element 240 is disposed between the inner surface 427 of the hole 421 and a circumferential surface of the positioning pillar 219. In other words, the elastic element 240 surrounds the positioning pillar 219. An inner circumferential surface is provided with threads (not shown), and a fixing screw 241 is fixed to the positioning pillar 219 through the threads. In such arrangement, two ends of the elastic element 240 are placed against a nut portion 243 of the fixing screw 241 and the first flange 423 so that the elastic element 240 is slightly deformed and produces a resistant force. The switching device 40 is pushed to a predetermined position by the resistant force, so as to be positioned at the lens positioning portion 211. When the switching device is pulled up by an external force that is greater than the resistant force, the elastic element 240 is further compressed until the nut portion 243 of the fixing screw 241 is placed against the second flange 425. In the first embodiment, a diameter of the opening hole 221 substantially equals a outer diameter of the positioning ring 431. When the switching device 40 is positioned at the lens positioning portion 211, the positioning rings 431 of the switching device 40 are tightly fitted in the opening holes 221 of the lens positioning portion 211 so that the switching device 40 cannot be rotated with respect to the seat body 21.

As shown in FIG. 5, an elastic element 230 is disposed in the guiding groove 213. The first supporting arm 23 has a sliding portion 231 and is connected to the seat body 21 by an insertion of the sliding portion 231 into the guiding groove 213. In such arrangement, the first supporting arm 23 can be moved with respect to the seat body 21 by deforming the elastic element 230. In other words, the first supporting arm 23 is extended from a first end of the seat body 21 along the first axis and is provided with the elastic element 230.

Also as shown in FIG. 5, a first adjusting knob 51 has a first outer thread portion 511 and is penetrated out of the second supporting arm 25. The second supporting arm 25 is disposed on the seat body 21 by screwing the first outer thread portion 511 of the first adjusting knob 51 to the first thread hole 215. In other words, the second supporting arm 25 is extended from a second end of the seat body 21 along the first axis and is provided with the first adjusting knob 51. It is worth noting that the second supporting arm 25 is moved with respect to the seat body 21 along the first axis, when the first adjusting knob 51 is rotated with respect to the first thread hole 215.

As shown in FIG. 6, a second adjusting knob 71 has a second outer thread portion 711 and is penetrated out of the third supporting arm 27. The third supporting arm 27 is disposed on the seat body 21 by screwing the second outer thread portion 711 of the second adjusting knob 71 to the second thread hole 217. In other words, the third supporting arm 27 is extended from a third end of the seat body 21 along the second axis and is provided with the second adjusting knob 71. It is worth noting that the third supporting arm 27 is moved with respect to the seat body 21 along the second axis when the second adjusting knob 71 is rotated with respect to the second thread hole 217. If positions of the first supporting arm 23, the second supporting arm 25 and the third supporting arm 27 are fixed, the seat body 21 can be moved with respect to the first supporting arm 23, the second supporting arm 25 and the third supporting arm 27 by rotating the first adjusting knob 51 and the second adjusting knob 71.

The way to mount the switching device 40 to the electronic device 100 through the supporting frame 20 is described herein:

First, the first supporting arm 23 is moved with respect to the seat body 21 along the first axis by an external force applied by a user, so that a distance between the first supporting arm 23 and the second supporting arm 25 is greater than a width of the electronic device 100. Since the movement of the first supporting arm 25, the elastic element 230 is deformed and produces a recovering force that is opposite to the external force. The extension lens module 300 is moved toward the electronic device 100 by the user, so that the second supporting arm 25 and the third supporting arm 27 are placed against a left side and an upper side of the electronic device 100. Meanwhile, the first supporting arm 23 is outside a right side of the electronic device 100 (that is, the first supporting arm 23 is not placed against the electronic device 100) because of the external force. After the user releases the first supporting arm 23 (that is, after the external force is removed), the first supporting arm 23 is moved with respect to the seat body 21 along the first axis by the recovering force of the elastic element 230, and the distance between the first supporting arm 23 and the second supporting arm 25 is shortened. Therefore, the electronic device 100 is tightly held between the first supporting arm 23 and the second supporting arm 25.

Although the switching device 40 has been mounted on the electronic device 100 by means of the supporting frame 20, an adjustment must be further executed for directing the extension lens 403a of the switching device 40 at a lens (not shown) of the electronic device 100. In a condition that the electronic device 100 is held between the first supporting arm 23, the second supporting arm 25 and the third supporting arm 27 (that is, the positions of the first supporting arm 23, the second supporting arm 25 and the third supporting arm 27 are fixed), the user can move the seat body 21 with respect to the first supporting arm 23, the second supporting arm 25 and the third supporting arm 27 by rotating the first adjusting knob 51 and the second adjusting knob 71 so as to direct the extension lens 403a of the switching device 40 at the lens of the electronic device 100.

In the first embodiment, the user rotates the first adjusting knob 51 to move the seat body 21 (or the switching device 40) with respect to the second supporting arm 25 along the first axis, so that a center of the extension lens 403a and a center of the lens of the electronic device 100 are arranged along a vertical line. During the movement of the seat body 21, the elastic element 230 is stretched or compressed to be deformed, so that the first supporting arm 23 is continuously forced against the right side of the electronic device 100. The user then rotates the second adjusting knob 71 to move the seat body 21 (or the switching device 40) with respect to the third supporting arm 27 along the second axis, so that the center of the extension lens 403a and the center of the lens of the electronic device 100 are aligned with each other.

It is understood that an end surface of the electronic device 100 that contacts the first supporting arm 23, the second supporting arm 25 or the third supporting arm 27 can be provided with a buffer element (not shown). The buffer element is configured to protect the electronic device 100 from damage because of scratching or clamping by the supporting frame 20. In the first embodiment, the buffer element is soft glue or a sponge.

In the first embodiment, each of the positioning rings 431 has a height H (as shown in FIG. 5), and the height H equals a rear focal length of the extension lens 403a, the extension lens 403b or the extension lens 403c. The rear focal length is defined as a distance from an end surface of the extension lens to a surface of the lens of the electronic device 100. The extension lenses with different camera functions (e.g. macro, telephoto or wide-angle camera function) usually have different rear focal lengths. In the present embodiment, the rear focal length of the extension lens 403a, the extension lens 403b or the extension lens 403c is determined by adjusting the height of the positioning ring 431. That is, the height of the positioning ring 431 is determined by the rear focal length of the extension lens, so that the extension lens is provided with well quality of imaging. A height of the opening hole 221 is smaller than the height H of the positioning ring 431. When the center of the extension lens 403a and the center of the lens of the electronic device 100 are in alignment, the positioning ring 431 corresponding to the extension lens 403a is directed at the lens of the electronic device 100 and is placed against the lens of the electronic device 100 for satisfying optical design of the rear focal length of the extension lens 403a, so as to ensure quality of imaging. Furthermore, by the design of the positioning ring 431, the center of the extension lens 403a and the center of the lens of the electronic device 100 can be rapidly and accurately positioned with respect to each other.

After the above-described adjustment, the extension lens module 300 and the electronic device 100 are arranged as shown in FIG. 1. The user can operate the electronic device 100 to photograph as well as can apply the camera function of the extension lens 403a of the switching device 40. If applying the camera function of the extension lens 403b or the extension lens 403c is desired, the user can simply operate the switching device 40. The operation of the switching device 40 is described herein:

In operation, the rotating disc 401 of the switching device 40 is pulled up from the lens positioning portion 211 to leave the predetermined position in a direction that is perpendicular to the electronic device 100 (that is, in the extending direction of the positioning pillar 219), so that the elastic element 240 is further compressed and the positioning rings 431 leave the opening holes 221. Meanwhile, the switching device 40 is released from being positioned and is rotatable with respect to the positioning pillar 219 of the lens positioning portion 211. The rotating disc 401 is then rotated to move the extension lenses 403a-403c with respect to the positioning pillar 219 in a circumferential direction of the positioning pillar 219 until a center of the extension lens 403b or the extension lens 403c is aligned with the center of the lens of the electronic device 100. Finally, the switching device 40 is released by the user, and the rotating disc 401 is pushed back by the resistant force of the elastic element 240. Therefore, the positioning ring 431 on the extension lens 403b or the extension lens 403c is tightly fitted in the opening hole 221, so that the switching device 40 is positioned at the lens positioning portion 211 again. In the present embodiment, the center of the opening hole 221 is overlapped with the center of the lens of the electronic device 100 by adjusting the supporting arms. Also, by the design of the positioning ring 431, the position deviation of the center of the extension lens from the center of the lens of the electronic device 100 is well controlled. By way of positioning that is described in the present embodiment, the invention is provided with small tolerance and high accuracy. Furthermore, by the design of the elastic element 240, it is ensured that the rotating disc 401 and the lens of the electronic device 100 are in contact with each other, so as to satisfying optical design of the extension lens. After the operation of the switching device 40 is finished, the user is able to apply the camera function of the extension lens 403b or the extension lens 403c. For the user, the above-described operation to switch the camera function is simple and convenient. Also, the risk of losing the extension lens can be reduced.

Further, the user can apply the external force to the first supporting arm 23, so as to increase the distance between the first supporting arm 23 and the second supporting arm 25 to be greater than the width of the electronic device 100. In such arrangement, the extension lens module 300 can be easily detached. It is worth noting that if it is desired to mount the extension lens module 300 on the electronic device 100 again, the user can clamp the electronic device 100 with the first supporting arm 23, the second supporting arm 25 and the third supporting arm 27 according to the above-described mounting way, so that the center of the extension lens 403a, the extension lens 403b or the extension lens 403c is aligned with the center of the lens of the electronic device 100. In other words, if the relative position between the switching device 40 and the electronic device 100 has been adjusted at first mounting, it is not required to adjust the extension lens module 300 again at second mounting when the electronic device 100 is of the same type.

It is understood that by the above-described mounting and adjusting way, the extension lens module 300 of the first embodiment of the invention can be applied to the electronic device 100 of any type, without limiting the electronic device 100 to be used along with a special protective case. Therefore, the cost can be reduced and the original design of the electronic device 100 can be reserved. It is worth noting that even if the user applies a protective case (not shown) to the electronic device 100, the user can still align the center of the extension lens 403a of the extension lens module 300 with the center of the lens of the electronic device 100 according to the above-described mounting and adjusting way, so that both the accuracy of positioning and quality of imaging can be ensured.

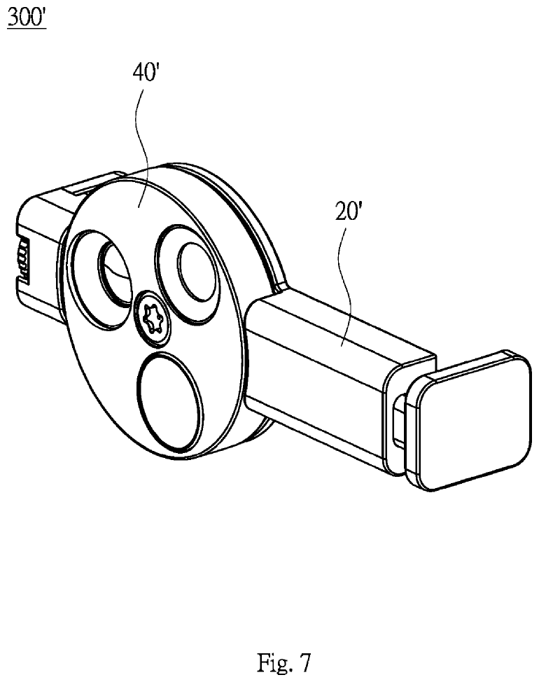

Referring to FIG. 7, an extension lens module 300′ in accordance with a second embodiment of the invention includes a supporting frame 20′ and a switching device 40′. The difference between the second embodiment and the first embodiment is that the third supporting arm 27 and related structure thereof are omitted. The arrangement of other elements and operation of the second embodiment are similar to those of the first embodiment described above, and therefore the descriptions thereof are omitted.

In the first embodiment (or the second embodiment), the seat body 21 is disposed on the electronic device 100 by clamping of the supporting arms. However, the invention is not limited thereto, and the seat body 21 can be disposed on the electronic device 100 by means of sticking or in other mounting ways.

What is claimed is:

1. An extension lens module for an electronic device having a lens, comprising:
a seat body configured to be detachably disposed on the electronic device and comprising a positioning pillar; and
a switching device comprising a rotating disc and a plurality of extension lenses, wherein the rotating disc is rotatable with respect to the seat body in an extending direction which is perpendicular to the seat body, and the extension lenses are disposed on the rotating disc at intervals.

2. The extension lens module as claimed in claim 1, wherein the rotating disc comprises a hole, the positioning pillar is penetrated through the hole, so that the rotating disc is movable with respect to the seat body in the extending direction.

3. The extension lens module as claimed in claim 1, wherein the rotating disc comprises a plurality of positioning rings, and positions in which the extension lenses are disposed on the rotating disc correspond to positions of the positioning rings on the rotating disc;
wherein when one of the positioning rings is directed at the lens of the electronic device and is in contact with the electronic device, the extension lens corresponding to the positioning ring is aligned with the lens of the electronic device.

4. The extension lens module as claimed in claim 3, wherein a first supporting arm is extended from a first end of the seat body along a first axis, a second supporting arm is extended from a second end of the seat body that is opposite to the first end along the first axis, and one of the first supporting arm and the second supporting arm is provided with an elastic element so that the electronic device is held between the first supporting arm and the second supporting arm.

5. The extension lens module as claimed in claim 4, wherein the other one of the first supporting arm and the second supporting arm is provided with a first adjusting knob configured to move the switching device along the first axis.

6. The extension lens module as claimed in claim 5, wherein a third supporting arm is extended from a third end of the seat body along a second axis, the second axis is perpendicular to the first axis, and the third supporting arm is provided with a second adjusting knob configured to move the switching device along the second axis.

7. The extension lens module as claimed in claim 6, wherein the rotating disc further comprises a hole, an elastic element is disposed between the positioning pillar of the seat body and an inner surface of the hole of the rotating disc, the seat body further comprises at least one opening hole, the opening hole is configured to allow an optical axis of one of the extension lenses to pass through, a height of the opening hole is smaller than a height of each of the positioning rings, the opening hole is configured to accommodate one of the positioning rings, and a diameter of the opening hole equals an outer diameter of each of the positioning rings so that each of the positioning rings can be tightly fitted in the opening hole, each of the positioning rings has a height, and the height equals a rear focal length of the extension lens corresponding to the positioning ring.

8. The extension lens module as claimed in claim 3, wherein each of the positioning rings has a height, and the height equals a rear focal length of the extension lens corresponding to the positioning ring.

9. The extension lens module as claimed in claim 8, wherein the seat body further comprises at least one opening hole, a height of the opening hole is smaller than a height of each of the positioning rings, the opening hole is configured to accommodate one of the positioning rings, and a diameter of the opening hole equals an outer diameter of each of the positioning rings so that each of the positioning rings can be tightly fitted in the opening hole.

10. The extension lens module as claimed in claim 9, wherein the rotating disc further comprises a hole, an elastic element is disposed between the positioning pillar of the seat body and an inner surface of the hole of the rotating disc, the opening hole is configured to allow an optical axis of one of the extension lenses to pass through.

11. The extension lens module as claimed in claim 3, wherein the seat body further comprises at least one opening hole, a height of the opening hole is smaller than a height of each of the positioning rings, the opening hole is configured to accommodate one of the positioning rings, and a diameter of the opening hole equals an outer diameter of each of the positioning rings so that each of the positioning rings can be tightly fitted in the opening hole.

12. The extension lens module as claimed in claim 1, wherein a first supporting arm is extended from a first end of the seat body along a first axis, a second supporting arm is extended from a second end of the seat body that is opposite to the first end along the first axis, and one of the first supporting arm and the second supporting arm is provided with an elastic element so that the electronic device is held between the first supporting arm and the second supporting arm.

13. The extension lens module as claimed in claim 12, wherein the other one of the first supporting arm and the second supporting arm is provided with a first adjusting knob configured to move the switching device along the first axis.

14. The extension lens module as claimed in claim 12, wherein a third supporting arm is extended from a third end of the seat body along a second axis, the second axis is perpendicular to the first axis, and the third supporting arm is provided with a second adjusting knob configured to move the switching device along the second axis.

15. The extension lens module as claimed in claim 1, wherein the rotating disc comprises a plurality of positioning rings, each of the positioning rings has a height, and the height equals a rear focal length of the extension lens corresponding to the positioning ring.

16. The extension lens module as claimed in claim 1, wherein the rotating disc comprises a plurality of positioning rings, the seat body further comprises at least one opening hole, a height of the opening hole is smaller than a height of each of the positioning rings, the opening hole is configured to accommodate one of the positioning rings, and a diameter of the opening hole equals an outer diameter of each of the positioning rings so that each of the positioning rings can be tightly fitted in the opening hole.
